(19) United States
(12) Patent Application Publication
(10) Pub. No.: US 2014/0205514 A1
(43) Pub. Date: Jul. 24, 2014

(54) BLOOD SEPARATING VESSEL FOR EXTRACTING AUTOLOGOUS PLATELETS, AND APPARATUS FOR EXTRACTING AUTOLOGOUS PLATELETS

(71) Applicant: Eui Jae HWANG, Incheon (KR)

(72) Inventor: Eui Jae HWANG, Incheon (KR)

(21) Appl. No.: 14/219,432

(22) Filed: Mar. 19, 2014

Related U.S. Application Data
(63) Continuation of application No. PCT/KR2012/005675, filed on Jul. 17, 2012.

(30) Foreign Application Priority Data
Sep. 22, 2011 (KR) 10-2011-0095926

(51) Int. Cl. B01L 3/00

(52) U.S. Cl. CPC B01L 3/508
USPC 422/533

(57) ABSTRACT

Provided is a blood separating vessel for extracting autologous platelets, and an apparatus for extracting autologous platelets. The blood separating vessel for extracting autologous platelets comprises: a main body defining an internal space divided into an upper fluid chamber and a lower fluid chamber; an upper cover disposed to seal an upper portion of the upper fluid chamber; a lower cover disposed to seal a lower portion of the lower fluid chamber, the lower cover being coupled such that an outer peripheral surface of the lower cover is elevatable in a state of being in close contact along an inner peripheral surface of the lower fluid chamber by an external force applied upward; and a fluid collection part dividing the internal space into the upper fluid chamber and the lower fluid chamber and including a fluid passage protruding upward to communicate the upper fluid chamber with the lower fluid chamber.

### TECHNICAL FIELD

The present invention relates to a blood separating vessel for extracting autologous platelets, and an apparatus for extracting autologous platelets.

### BACKGROUND ART

Blood carries out various functions. For example, blood delivers oxygen taken by lungs to tissue cells, and transports carbon dioxide from tissue cells back to the lungs. Blood delivers nutrients absorbed by the alimentary canal to organs or tissue cells. Blood transports degradation products of tissues, which are unnecessary for a living body, to a kidney for discharge to the outside of the body. Blood delivers hormones secreted by endocrine glands to acting organs or tissues, and keeps body temperature constant by equally distributing body heat. In addition, blood destroys or eliminates invading germs or foreign substances.

Such blood is used as an important index for determining various diseases or health conditions. Platelets abundantly containing growth factors in the blood are used for therapeutic purposes. Blood is composed of red blood cells, white blood cells, and platelets. The platelets mainly exist in a plasma. The plasma is divided into a platelet rich plasma (PRP) and a platelet poor plasma (PPP). The PRP is transplanted into a pain area, in particular, knees, ligaments, muscles, and the like, and stimulates stem cells to help create cells. As such, the PRP has been used for therapeutic purposes.

Since the PRP is a small amount of about 1% in the collected blood and its viscosity is high, it is difficult to separate the PRP from red blood cells. Therefore, research has been actively conducted on technologies for extracting a PRP other than from red blood cells. Generally, after blood collected from a human body is injected into a PRP separating vessel, the PRP is extracted using a centrifuge. In the past, a test tube has been commonly used as the PRP separating vessel. However, since the PRP extraction is inconvenient, a separating vessel with a fluid chamber divided into two chambers has recently been developed and used.

The PRP extracting method using the conventional separating vessel with the two divided chambers will be described below.

First, blood collected from a human body is injected into the separating vessel, and a centrifugation is performed using a centrifuge. When the centrifugation is completed, the blood is separated into three stages, that is, red blood cells, PRP, and plasma in this order from the lower portion of the separating vessel due to a specific gravity difference. In order to extract only the PRP in the state in which the blood is separated into the three stages, the red blood cells are ascended up to a portion where the fluid chamber is divided into two chambers, and the PRP is selectively extracted using a syringe.

In such a conventional separating vessel, a separate elevating member is installed in a lower portion to ascend the red blood cells up to the divided portion so as to selectively extract the PRP. In this case, the elevating member is manufactured in a form of a lower cover sealing a lower portion of the separating vessel.

However, in the conventional separating vessel, since the elevating member capable of moving up and down is installed in the lower portion of the vessel in a screw type as described above, the elevating member is easily detached from the separating vessel after the PRP extraction. Hence, a reuse problem of the separating vessel frequently occurs. Since the separating vessel for extracting the PRP is designated as a disposable pathological waste, the separating vessel should not be reused. However, since the separating vessel is relatively expensive, the separating vessel is reused after disinfection and sterilization.

### CITATION LIST

### Patent Literature

Patent Literature 1: KR 10-1026599 B1, 2011 Mar. 25. pp. 3-6

Patent Literature 2: KR 10-2011-0009651 A, 2011 Jan. 28. pp. 3-7

### SUMMARY OF INVENTION

### Technical Problem

Therefore, the present invention has been made in an effort to solve the problems of the related art and have the following objects.

First, an object of the present invention is to provide a blood separating vessel for extracting autologous platelets, and apparatus for extracting autologous platelets, the reuse of which is prevented.

Second, another object of the present invention is to provide blood separating vessel for extracting autologous platelets, and apparatus for extracting autologous platelets, which is capable of preventing damage of a lower portion of a separating vessel coming into contact with a centrifuge when centrifugation is performed using the centrifuge.

### Solution to Problem

According to an aspect for achieving the above objects, a blood separating vessel for extracting autologous platelets, comprising: a main body defining an internal space divided into an upper fluid chamber and a lower fluid chamber; an upper cover disposed to seal an upper portion of the upper fluid chamber; a lower cover disposed to seal a lower portion of the lower fluid chamber, the lower cover being coupled such that an outer peripheral surface of the lower cover is elevatable in a state of being closely contacted along an inner peripheral surface of the lower fluid chamber by an external force applied upward; and a fluid collection part dividing the internal space into the upper fluid chamber and the lower fluid chamber and including a fluid passage protruding upward to communicate the upper fluid chamber with the lower fluid chamber.

The upper cover may include an injection port in a central portion facing the fluid passage so as to inject blood collected from a human body through the fluid passage or extract a autologous platelets separated from the blood.

The fluid collection part may include inlet ports provided on both sides of the fluid passage to guide blood of the upper fluid chamber to the inside of the lower fluid chamber.

The blood separating vessel may further include opening/closing members, upper portions of which are elevatably coupled to the upper cover such that lower portions of the opening/closing member open and close the inlet ports of the fluid collection part.

Each of the opening/closing members may include: a cover portion coupled to the upper cover such that the cover portion passes through the upper cover, a diameter of an upper end of the cover portion being larger than a diameter of a lower end of the cover portion; and an insertion portion extending downward from the cover portion and being formed to have a rod shape covering the inlet port, such that the insertion portion seals the inlet port during an elevating operation of the cover portion.

The fluid collection part may have a mountain-shaped structure protruding upward from both sides where the inlet ports are formed to a central portion where the fluid passage is formed.

The blood separating vessel may further comprise a locking hook disposed on an outer peripheral surface of the main body corresponding to the upper fluid chamber, such that the locking hook is locked to a centrifuge when the blood separating vessel is mounted on the centrifuge.

Also, according to an aspect for achieving the above objects, an apparatus for extracting autologous platelets, comprising: a vessel including a first main body defining an internal space divided into an upper fluid chamber and a lower fluid chamber; an upper cover sealing the upper fluid chamber; a lower cover sealing the lower fluid chamber by being coupled to be ascendible in such a state that an outer peripheral surface of the lower cover comes into close contact with an inner peripheral surface of the lower fluid chamber; and a fluid collection part dividing the internal space into the upper fluid chamber and the lower fluid chamber and including a fluid passage protruding upward from a central portion to communicate the upper fluid chamber and the lower fluid chamber; a second main body including a space portion in which the vessel is accommodated and mounted; a side opening which is provided in one side portion and into which the vessel is inserted in a width direction such that the vessel is guided to the space portion; an upper opening which is provided in an upper portion to expose a part of the upper cover; and a lower opening which is provided in a lower portion to expose a part of the lower cover; and an ascending portion, a part of which passes through the lower opening of the second main body, is inserted into the second main body, is elevatably coupled to the lower portion of the second main body, and ascends the lower cover of the vessel mounted in the space portion by an ascending operation to vary a variation in a volume of the lower fluid chamber.

the upper cover may includes an injection port in a central portion facing the fluid passage so as to inject blood collected from a human body through the fluid passage or extract a autologous platelets separated in the vessel.

the fluid collection part may include inlet ports provided on both sides of the fluid passage to guide blood of the upper fluid chamber to the inside of the lower fluid chamber.

The apparatus may further comprise opening/closing members, upper portions of which are elevatably coupled to the upper cover such that lower portions of the opening/closing member open and close the inlet ports of the fluid collection part.

each of the opening/closing members may include: a cover portion coupled to the upper cover such that the cover portion passes through the upper cover, a diameter of an upper end of the cover portion being larger than a diameter of a lower end of the cover portion; and an insertion portion extending downward from the cover portion and being formed to have a rod shape covering the inlet port, such that the insertion portion seals the inlet port during an elevating operation of the cover portion.

The fluid collection part may have a mountain-shaped structure protruding upward from both sides where the inlet ports are formed to a central portion where the fluid passage is formed.

The upper opening may be formed in a size smaller than a diameter of the upper cover, and the lower opening is formed in a size smaller than a diameter of the lower cover.

The apparatus may further comprise a locking hook disposed on an outer peripheral surface of the first main body corresponding to the upper fluid chamber, such that the locking hook is locked to a centrifuge when the vessel is mounted on the centrifuge.

### Advantageous Effects of Invention

As described above, according to the present invention, the lower cover sealing the lower portion of the separating vessel is installed to be inserted into the separating vessel and in not the elevating structure but the ascending-only structure. Therefore, the reuse of the separating vessel can be fundamentally prevented.

In addition, according to the present invention, since the locking hook is formed on the outer peripheral surface of the separating vessel, the lower portion of the separating vessel and the centrifuge are installed spaced apart from each other by a predetermined distance when the centrifugation is performed using the centrifuge. Therefore, it is possible to prevent the damage of the lower portion of the separating vessel coming into contact with the centrifuge.

### BRIEF DESCRIPTION OF DRAWINGS

FIG. 1 is an assembly perspective view of a blood separating vessel for extracting autologous platelets according to an embodiment of the present invention.

FIG. 2 is an exploded perspective view of the vessel illustrated in FIG. 1.

FIG. 3 is a perspective view describing a procedure of assembling the vessel of FIG. 1 with a second main body.

FIG. 4 is a cross-sectional view illustrating a state in which the vessel of FIG. 3 is inserted into the second main body.

FIG. 5 is a cross-sectional view describing an operation characteristic of the separating apparatus illustrated in FIG. 3.

FIG. 6 is a cross-sectional view of a vessel according to another embodiment of the present invention.

### DESCRIPTION OF EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like elements throughout this disclosure.

Generally, according to a method of separating blood using a centrifugal force, blood is injected into a separating vessel, and a centrifugal force is applied thereof for several minutes at 1,000 to 4,000 rpm. At this time, the blood is separated into plasma in an upper portion and red blood cells in a lower portion. Thereafter, the PRP is matched with a boundary line where the PRP and the red blood cells are separated from each other, and a centrifugal force is applied using the centrifuge for several minutes at 500 to 3,000 rpm. In this manner, the PRP is separated. However, the height of the boundary line where the red blood cells and the plasma are separated from each other is different according to a person's perception. Thus, the PRP extraction is not easy. Therefore, the present invention is directed to provide a separating device used for separating and extracting a PRP by using a centrifugal force in a blood separating method so as to facilitate extraction in a PRP separating process using a centrifuge.

Hereinafter, technical features of the present invention will be described with reference to the accompanying drawings.

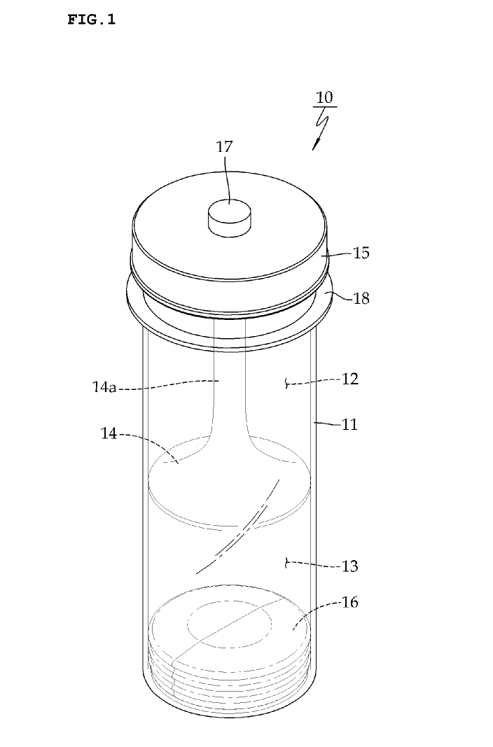

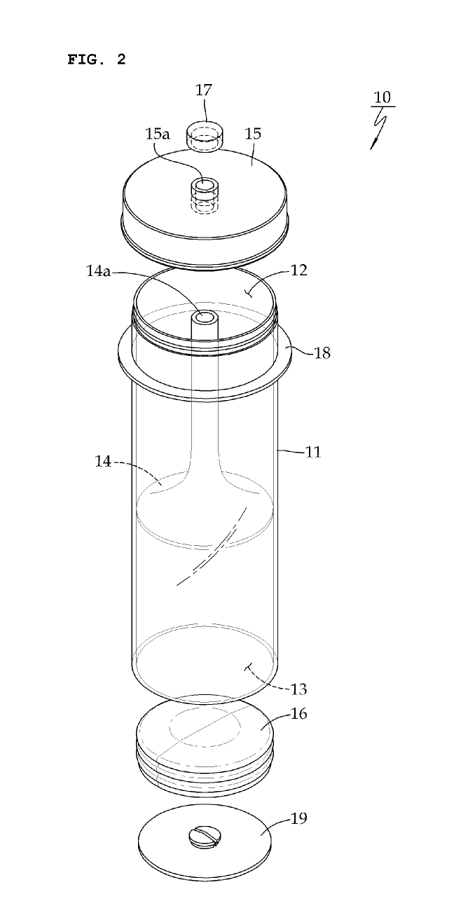

FIG. 1 is an assembly perspective view of a blood separating vessel for extracting autologous platelets according to an embodiment of the present invention, and FIG. 2 is an exploded perspective view of the vessel illustrated in FIG. 1.

Referring to FIGS. 1 and 2, the blood separating vessel 10 for extracting autologous platelets (for example, PRP) according to the embodiment of the present invention includes a first main body 11, an upper cover 15, a lower cover 16, and a fluid collection part 14. The first main body 11 defines an internal space divided into an upper fluid chamber 12 and a lower fluid chamber 13. The upper cover 15 seals the upper fluid chamber 12. The lower cover 16 seals the lower fluid chamber 13 by being coupled to be ascendible in such a state that an outer peripheral surface of the lower cover 16 comes into close contact with an inner peripheral surface of the lower fluid chamber 13. The fluid collection part 14 divides the internal space into the upper fluid chamber 12 and the lower fluid chamber 13, and includes a fluid passage 14a protruding upward from a central portion to couple between the upper fluid chamber 12 and the lower fluid chamber 13.

The first main body 11 may be made of a transparent material or a translucent material that allows an external user to see through to the internal space. The first main body 11 may have an opened upper portion and an opened lower portion, and may have a cylindrical structure such that the first main body 11 is mounted on a centrifuge and centrifugation is stably performed. The first main body 11 has a thread on an upper outer peripheral surface, and the upper cover 15 has a thread on an inner peripheral surface. The thread of the first main body 11 is coupled to the thread of the upper cover 15 to thereby seal the opened portion.

A locking hook 18 may be formed on the outer peripheral surface of the first main body 11 so as to prevent the lower portion of the vessel 10 from being damaged by collision against the centrifuge when the vessel 10 is mounted on the centrifuge. The locking hook 18 may be integrally formed with the first main body 11 by injection molding or compression molding, or may be provided as separate members. When the vessel 10 is mounted on the centrifuge, the locking hook 18 separates the lower portion of the vessel 10 from the centrifuge so as to prevent the lower portion of the vessel 10 from being damaged by collision against the centrifuge.

Meanwhile, as described above, in the conventional separating vessels, the lower cover sealing the lower portion of the vessel is coupled to surround the lower portion of the vessel, just like the upper cover of the present invention, and serves to protect the lower portion of the vessel during centrifugation. However, in the present invention, since the lower cover is inserted into the vessel, the lower portion of the vessel having a substantially relatively weak strength is mounted on the centrifuge in a state of being exposed to the outside. Consequently, as compared with the conventional separating vessels, it is likely that the vessel will be damaged during centrifugation.

Therefore, according to the present invention, the locking hook 18 is formed on the outer peripheral surface of the first main body 11, and the lower portion of the vessel 10 is separated from the centrifuge by a predetermined distance. In this manner, the friction between the lower portion of the vessel 10 and the centrifuge is fundamentally prevented to thereby minimize the damage of the lower portion of the vessel 10. As one example, the vessel 10 is inserted into an accommodation space of the centrifuge in a state of obliquely lying down. The locking hook 18 is put in the upper end of the centrifuge, so that the vessel 10 is disposed spaced apart from the lower portion of the accommodation space of the centrifuge.

As illustrated in FIG. 2, the upper cover 15 includes an injection port 15a in a central portion so as to inject blood collected from a human body through the fluid passage 14a or extract a PRP separated in the vessel 10. The injection port 15a is sealed by a packing member 17 made of a soft material such that a syringe needle might be inserted therein to, and is formed to face the fluid passage 14a.

The lower cover 16 is inserted through the lower opening of the first main body 11 to seal the lower fluid chamber 13. The lower cover 16 ascends into the lower fluid chamber 13 by a strong pressure upward from the rear surface, and varies a volume of the lower fluid chamber 13. Once the lower cover 16 is inserted in the lower fluid chamber 13, the lower cover 16 is coupled to the first main body so as not to descend downward.

As illustrated in FIGS. 1 and 2, the fluid collection part 14 is formed in a curved shape protruding from the outer portion toward the central portion, so as to prevent separated materials from being mixed together when the volume of the lower fluid chamber 13 is varied after the centrifugation. This is because the tapered shape may hinder the ascending of the PRP due to interference in the variation in the volume of the lower fluid chamber 13.

The fluid passage 14a of the fluid collection part 14 is disposed spaced apart from the inner surface (ceiling surface) of the upper cover 15 by a predetermined distance, the lower portion of the fluid collection part 14 communicates the lower fluid chamber 13, and the top portion of the fluid collection part 14 communicates with the upper fluid chamber 12. The fluid collection part 14 has a horn shape facing in a downward direction as a whole.

A protection member 19 may be coupled to a rear side of the lower cover 16 so as to protect the lower cover 16 when a strong pressure is applied to a rear surface of the lower cover 16. The protection member 19 is formed to have the same shape as the lower cover 16 such that the pressure applied from the rear surface of the lower cover 16 is uniformly transferred to the lower cover 16.

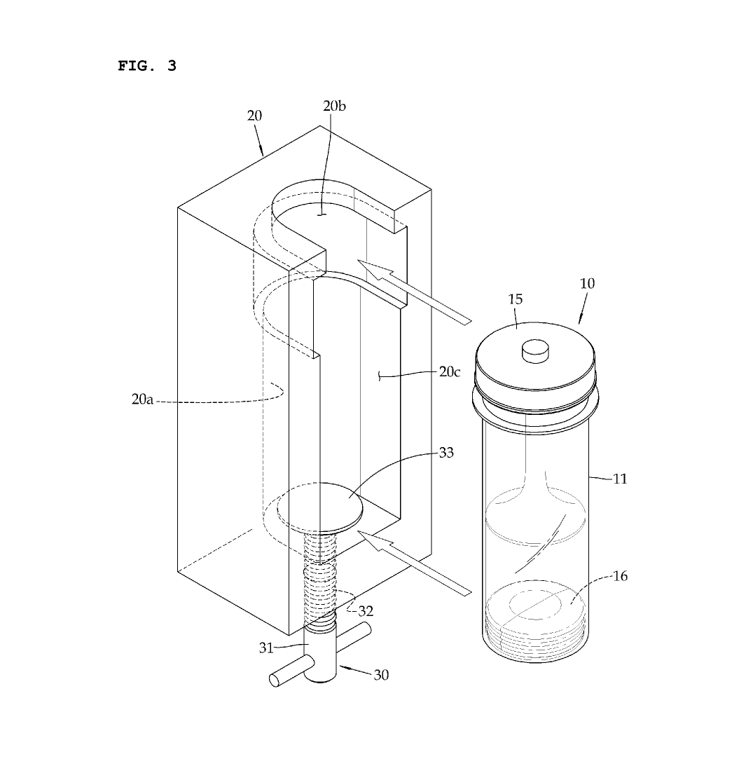

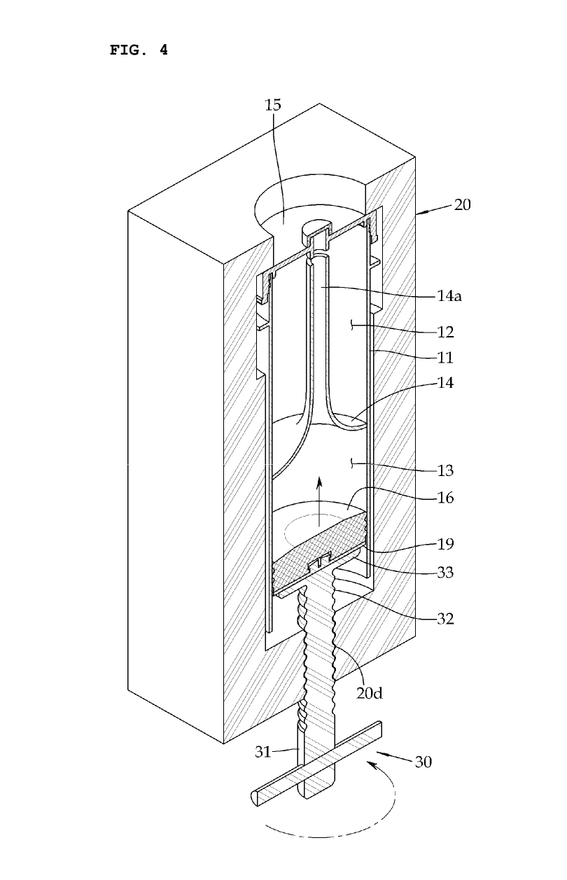

FIGS. 3 and 4 are perspective views of a blood separating vessel for extracting autologous platelets according to the embodiment of the present invention. Specifically, FIG. 3 is a perspective view describing a procedure of assembling the vessel 10 with a second main body 20, and FIG. 4 is a cross-sectional view illustrating a state in which the vessel 10 of FIG. 3 is inserted into the second main body 20.

Referring to FIGS. 3 and 4, an apparatus for extracting autologous platelets according to the embodiment of the present invention includes the second main body 20. The second main body 20 includes a space portion 20a in which the vessel 10 is accommodated and mounted. The second main body 20 includes a side opening 20c in one side portion, an upper opening 20b in an upper portion, and a lower opening 20d in a lower portion. The vessel 10 is inserted into the side opening 20c in a width direction (one direction) and is guided to the space portion 20a. The upper opening 20b exposes a part of the upper cover 15 of the vessel 10. The lower opening 20d exposes a part of the lower cover 16 of the vessel 10.

The upper opening 20b is formed in a size smaller than a diameter of the upper cover 15, and the lower opening 20d is formed in a size smaller than a diameter of the lower cover 16. Therefore, after the vessel 10 is inserted into the space portion 20a of the second main body 20, the vessel 10 is not released from the second main body 20 when a pressure is applied upward from the rear side of the lower cover 16.

As illustrated in FIG. 4, the apparatus for extracting autologous platelets according to the embodiment of the present invention includes an ascending portion 30. A part of the ascending portion 30 passes through the lower opening 20d of the second main body 20 and is inserted into the second main body 20. Therefore, the ascending portion 30 is coupled to the lower portion of the second main body in an elevatable manner. The ascending portion 30 ascends the lower cover 16 of the vessel 10 mounted in the space portion 20a by an ascending operation, resulting in a variation in the volume of the lower fluid chamber 13.

Specifically, the ascending portion 30 includes a manipulation portion 31, a coupling portion 32, and a support portion 33. The manipulation portion 31 is manipulated by a user's hand or a separate tool. The coupling portion 32 is coupled to the manipulation portion 31, and a part of the coupling portion 32 is inserted into the lower opening 20d of the second main body 20. A male thread is formed on an outer portion of the coupling portion 32, such that the coupling portion 32 is coupled to the second main body 20. The support portion 33 is disposed in an end portion of the coupling portion 32 and comes into close contact with the lower cover 16.

Meanwhile, the blood separating vessel for extracting autologous platelets according to the embodiment of the present invention may further include a release prevention member (not illustrated) that is coupled to the first main body 11 to surround the lower cover 16 during only centrifugation so as to prevent the lower cover 16 from being released from the first main body 11 by a rotating force during centrifugation. The release prevention member may have a circular cover and be screwed to the first main body 11 just like the upper cover 15. In this case, a thread is formed on the outer peripheral surface of the first main body 11, and a corresponding thread is also formed on an inner peripheral surface of the release prevention member. These threads are screwed to couple the release prevention member and the first main body 11 to each other. As another example, the release prevention member may be coupled to the first main body 11 by snap coupling. To this end, a locking protrusion is formed on the outer peripheral surface of the first main body 11, and a locking hook coupled to the locking protrusion is formed on the inner peripheral surface of the release prevention member.

Hereinafter, the operation characteristic of the blood separating vessel for extracting autologous platelets according to the embodiment of the present invention will be described.

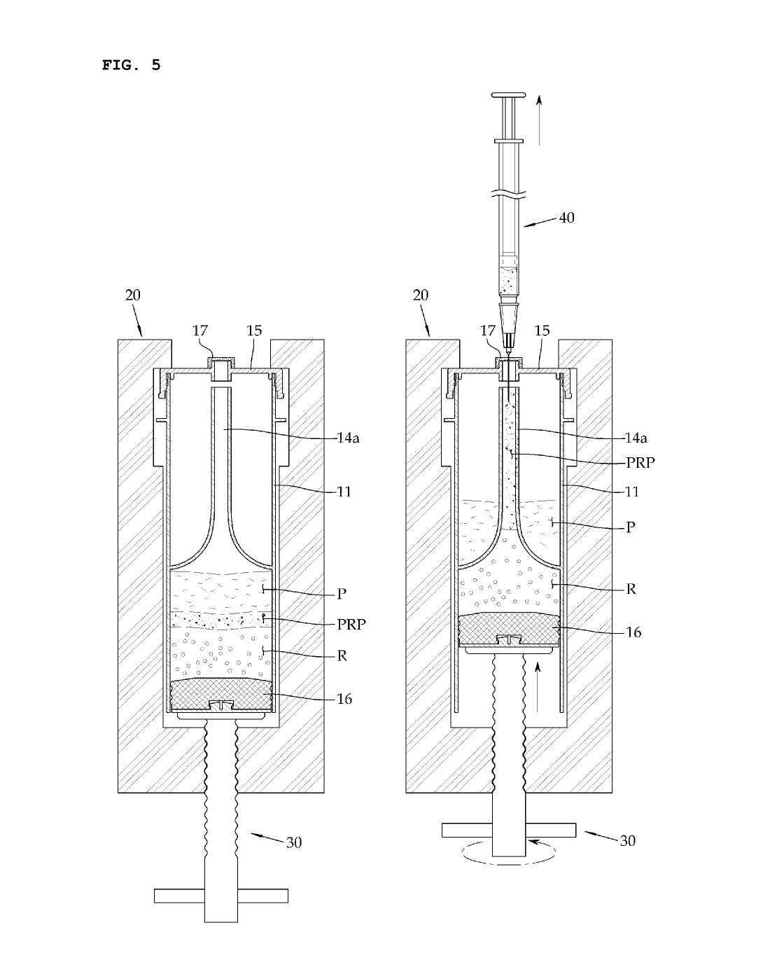

FIG. 5 is a cross-sectional view describing the operation characteristic of the apparatus for extracting autologous platelets according to the embodiment of the present invention. The left drawing of FIG. 5 illustrates a state in which a plasma (P), a PRP, a red blood cell (R) are separated in the vessel 10 after blood centrifugation, and the right drawing of FIG. 5 illustrates a procedure of ascending the lower cover 16 and extracting a PRP by using a syringe 40.

A procedure of assembling each element of the apparatus for extracting autologous platelets according to the embodiment of the present invention will be described with reference to FIG. 5. The upper cover 15 is screwed to the first main body 11 of the vessel 10 by using the threaded structure. The lower cover 16 is inserted into the lower portion of the first main body 11 by press fit. In this manner, the upper portion and the lower portion of the first main body 11 are sealed.

After the assembly is completed, blood collected from a human body is injected into the first main body 11 through the injection port 15a of the upper cover 15 and is centrifuged using the centrifuge (not illustrated). When the blood centrifugation is completed, the blood is centrifuged into three stages, that is, the PRP is located at an interface between the plasma (P) and the red blood cell (R) by the specific gravity difference as described above.

After the blood centrifugation, the vessel 10 is inserted into the space portion 20a through the side opening 20c of the second main body 20. Then, in order to extract the PRP from the lower fluid chamber 13, the manipulation portion 31 of the ascending portion 30 is manipulated to ascend the lower cover 16 and reduce the volume of the lower fluid chamber 13. That is, when the manipulation portion 31 is rotated clockwise to reduce the volume of the lower fluid chamber 13 by using the ascending portion 30 so as to extract only the PRP, the lower cover 16 ascends by the screw operation and the volume of the lower fluid chamber 13 is reduced.

Therefore, a part of the plasma (P) received in the lower fluid chamber 13 ascends by the ascending of the lower cover 16 and flows into the upper fluid chamber 12 through the fluid passage 14a. Then, when the lower cover 16 continuously ascends, the plasma received in the lower fluid chamber 13 flows into the upper fluid chamber 12 through the fluid passage 14a. The PRP exists within the fluid passage 14a, and the red blood cell (R) is disposed in the lower portion of the PRP. As such, the separated state is maintained. Then, the PRP existing within the fluid passage 14a is extracted through the injection port 15a of the upper cover 15 by using the syringe 40. In this manner, the PRP can be easily separated and extracted.

In such a method, since the vessel 10, from which the PRP is extracted, is in a state in which the lower cover 16 ascends to a predetermined height, the vessel 10 cannot be reused. That is, since the lower cover 16 according to the present invention can be gradually ascended within the first main body 11 but cannot be lowered, the vessel 10 cannot be fundamentally reused after PRP extraction.

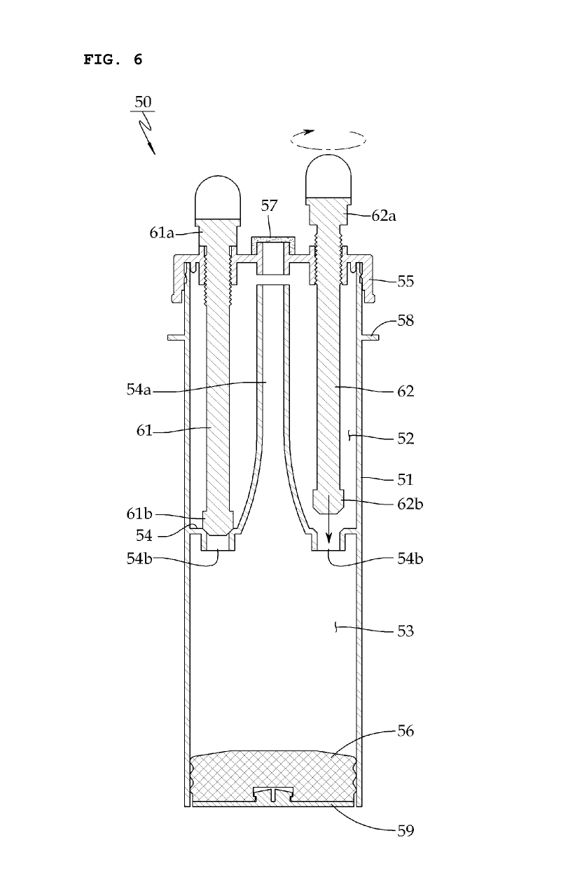

FIG. 6 is a cross-sectional view of a vessel 50 according to another embodiment of the present invention.

Referring to FIG. 6, the vessel 50 according to another embodiment of the present invention has a structure similar to the vessel 10 illustrated in FIGS. 1 and 2. However, a fluid collection part 54 includes inlet ports 54b, with a fluid passage 54a interposed therebetween, so as to guide blood of an upper fluid chamber 52 to the inside of a lower fluid chamber 53.

The vessel 50 includes opening/closing members 61 and 62 elevatably coupled to an upper cover 55 such that lower portions of the opening/closing members 61 and 62 open and close the inlet ports 54b of the fluid collection part 54. The opening/closing members 61 and 62 include cover portions 61a and 62a and insertion portions 61b and 62b, respectively. The cover portions 61a and 62a are coupled to the upper cover 55 such that the cover portions 61a and 62a pass through the upper cover 55, and a diameter of upper ends of the cover portions 61a and 62a is larger than a diameter of lower ends of the cover portions 61a and 62a. The insertion portions 61b and 62b extend downward from the cover portions 61a and 62a and are formed to have a rod shape covering the inlet ports 54b. The insertion portions 61b and 62b seal the inlet ports 54b during the elevating operation of the cover portions 61a and 62a.

Since the other elements, for example, a packing member 57, a lower cover 56, a protection member 59, and a locking hook 58, have the same structure as those (e.g., a packing member 17, a lower cover 16, a protection member 19, a locking hook 18, etc.) of the vessel 10 illustrated in FIGS. 1 and 2, a detailed description thereof will be omitted herein for conciseness.

While the present invention has been shown and described in connection with the exemplary embodiments, it will be apparent to those skilled in the art that modifications and variations can be made without departing from the spirit and scope of the invention as defined by the appended claims.

1. A blood separating vessel for extracting autologous platelets, comprising:
a main body defining an internal space divided into an upper fluid chamber and a lower fluid chamber;
an upper cover disposed to seal an upper portion of the upper fluid chamber;
a lower cover disposed to seal a lower portion of the lower fluid chamber, the lower cover being coupled such that an outer peripheral surface of the lower cover is elevatable in a state of being in close contact along an inner peripheral surface of the lower fluid chamber by an external force applied upward; and
a fluid collection part dividing the internal space into the upper fluid chamber and the lower fluid chamber and including a fluid passage protruding upward to communicate the upper fluid chamber with the lower fluid chamber.

2. The blood separating vessel of claim 1, wherein the upper cover includes an injection port in a central portion facing the fluid passage adapted to receive injected blood collected from a human body through the fluid passage or extract autologous platelets separated from the blood.

3. The blood separating vessel of claim 1, wherein the fluid collection part includes inlet ports provided on both sides of the fluid passage to guide blood of the upper fluid chamber to the inside of the lower fluid chamber.

4. The blood separating vessel of claim 3, comprising opening/closing members, upper portions of which are elevatably coupled to the upper cover such that lower portions of the opening/closing member open and close the inlet ports of the fluid collection part.

5. The blood separating vessel of claim 4, wherein each of the opening/closing members includes:
a cover portion coupled to the upper cover such that the cover portion passes through the upper cover, a diameter of an upper end of the cover portion greater than a diameter of a lower end of the cover portion; and
an insertion portion extending downward from the cover portion and formed to have a rod shape covering the inlet port, such that the insertion portion seals the inlet port during an elevating operation of the cover portion.

6. The blood separating vessel of claim 3, wherein the fluid collection part has a mountain-shaped structure protruding upward from both sides where the inlet ports are formed to a central portion where the fluid passage is formed.

7. The blood separating vessel of claim 1, comprising a locking hook disposed on an outer peripheral surface of the main body corresponding to the upper fluid chamber, such that the locking hook is locked to a centrifuge when the blood separating vessel is mounted on the centrifuge.

8. An apparatus for extracting autologous platelets, comprising:
a vessel including:
a first main body defining an internal space divided into an upper fluid chamber and a lower fluid chamber;
an upper cover sealing the upper fluid chamber;
a lower cover sealing the lower fluid chamber and coupled to be ascendible in such a state that an outer peripheral surface of the lower cover comes into close contact with an inner peripheral surface of the lower fluid chamber; and
a fluid collection part dividing the internal space into the upper fluid chamber and the lower fluid chamber and including a fluid passage protruding upward from a central portion to communicate the upper fluid chamber and the lower fluid chamber;
a second main body including:
a space portion in which the vessel is accommodated and mounted;
a side opening provided in one side portion and configured to receive the vessel inserted in a width direction such that the vessel is guided to the space portion;
an upper opening provided in an upper portion to expose a part of the upper cover; and
a lower opening provided in a lower portion to expose a part of the lower cover; and
an ascending portion, a part of which passes through the lower opening of the second main body, is inserted into the second main body, is elevatably coupled to the lower portion of the second main body, and ascends the lower cover of the vessel mounted in the space portion by an ascending operation to vary a variation in a volume of the lower fluid chamber.

9. The apparatus of claim 8, wherein the upper cover includes an injection port in a central portion facing the fluid passage adapted to receive injected blood collected from a human body through the fluid passage or extract autologous platelets separated in the vessel.

10. The apparatus of claim 8, wherein the fluid collection part includes inlet ports provided on both sides of the fluid passage to guide blood of the upper fluid chamber to the inside of the lower fluid chamber.

11. The apparatus of claim 10, comprising opening/closing members, upper portions of which are elevatably coupled to the upper cover such that lower portions of the opening/closing member open and close the inlet ports of the fluid collection part.

12. The apparatus of claim 11, wherein each of the opening/closing members includes:
a cover portion coupled to the upper cover such that the cover portion passes through the upper cover, a diameter of an upper end of the cover portion being larger than a diameter of a lower end of the cover portion; and
an insertion portion extending downward from the cover portion and formed to have a rod shape covering the inlet port, such that the insertion portion seals the inlet port during an elevating operation of the cover portion.

13. The apparatus of claim 10, wherein the fluid collection part has a mountain-shaped structure protruding upward from both sides where the inlet ports are formed to a central portion where the fluid passage is formed.

14. The apparatus of claim 8, wherein the upper opening is formed with diameter less than a diameter of the upper cover, and the lower opening is formed with a diameter less than a diameter of the lower cover.

15. The apparatus of claim 8, further comprising a locking hook disposed on an outer peripheral surface of the first main body corresponding to the upper fluid chamber, such that the locking hook is locked to a centrifuge when the vessel is mounted on the centrifuge.
